(19) United States
(12) Patent Application Publication
(10) Pub. No.: US 2021/0007301 A1
(43) Pub. Date: Jan. 14, 2021

(54) SELF-WATERING MODULAR PLANTER TOWER AND METHOD OF USE AND MANUFACTURING THE SAME

(71) Applicant: Thinh Hoang Do, Ho Chi Minh City (VN)

(72) Inventor: Thinh Hoang Do, Ho Chi Minh City (VN)

(73) Assignee: Ton Duc Thang University

(21) Appl. No.: 16/006,843

(22) Filed: Jun. 13, 2018

(51) Int. Cl. A01G 27/00; A01G 27/04; A01G 9/02

(52) U.S. Cl. CPC A01G 27/005; A01G 9/027; A01G 9/023; A01G 27/04

(57) ABSTRACT

A self-watering modular planter and method of use and fabricating the same are disclosed which includes a plurality of modular trays having a growing medium and a water tank; an extendable frame skeleton capable of inserting into each of plurality of modular trays to secure the plurality of modular trays; an array of capillary tubes, disposed vertically along the top surface and in fluid communication with said water tank, configured to provide water to soils in each modular tray by the capillary action.

### FIELD OF THE INVENTION

This invention generally relates to plant cultivation. More specifically, this invention relates to a stackable planter for growing plants and vegetables capable of self-watering.

### BACKGROUND OF ART

As the urbanization trend continues to expand, agricultural lands are receded by the advancing of commercial buildings and high-rise condominiums. People are moving by droves to urban cities to live and to find jobs. Residential housing urban green spaces are adversely reduced. As a consequence, there are insufficient urban spaces to grow vegetation to achieve aesthetic, health, and environmental benefits.

Modern urban life style is associated with chronic stress and insufficient time to take care and water the urban green vegetation. Residents need to grow plants and vegetables to improve greenery, psychological relaxation and stress alleviation, scenery, and to reduce exposure to anthropogenic hazards such as air pollutants, noise and excessive heat. To grow sufficient greenery for benefits, traditional clay pots and modular trays for growing plants and vegetables usually occupy a large amount of spaces. More than often, clays and pots are arranged in a two dimensional horizontal array—those are closer to the water source get superfluous watering and those are further away gets insufficient watering. Either over watering or under watering causes plants and vegetables grown in pots and modular trays to wither. Elaborate watering system is expensive and often malfunctions causing waste of water.

Therefore, it is essential to provide urban residents with a growing media that fits into their limited urban spaces for decoration, for health, and for home-grown organic fruits and vegetables.

Thus, what is needed is a growing media and process that encourage urban residents to grow different types of plants, flowers, and vegetables without spending a lot of time to take care of them and without either over watering or under watering.

In addition, what is needed is cost effective and easy to assemble growing media that does not need an elaborate watering system.

The present invention provides the solutions to all of the above needs.

### SUMMARY OF THE INVENTION

Accordingly, an objective of the present invention is to provide a self-watering modular planter and a method of use and for fabricating the same are disclosed which includes a plurality of modular trays having a growing medium and a water tank; an extendable frame skeleton capable of inserting into each of plurality of modular trays to secure the plurality of modular trays; an array of capillary tubes, disposed vertically along the top surface and in fluid communication with said water tank, configured to provide water to soils in each modular tray by the capillary action.

Another objective of the present invention is to provide urban residents with a growing media that fits into their limited urban spaces for decoration, for health, and for home grown organic fruits and vegetables.

Yet another objective of the present invention is to provide a growing media and process that encourage urban residents to grow different types of plants; flowers, and vegetables without spending a lot of time to water them.

Yet another objective of the present invention is to provide a cost effective and easy to assemble growing media that does not need an elaborate watering system.

These and other advantages of the present invention will no doubt become obvious to those of ordinary skill in the art after having read the following detailed description of the preferred embodiments, which are illustrated in the various drawing Figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. is a three dimensional (3D) schematic diagram of a complete self-watering modular planter in accordance with an exemplary embodiment of the present invention.

FIG. 2 is a three-dimension (3D) of the interior of a stand-alone modular tray in accordance with an exemplary embodiment of the present invention.

FIG. 3A is a cut-away lateral view of the stand-alone modular tray of FIG. 2 seen from the left side that shows a growing media and a water tank in accordance with an exemplary embodiment of the present invention.

FIG. 3B is a cut-away lateral view of the stand-alone modular tray of FIG. 2 seen from the right side that shows a growing media and a water tank in accordance with an exemplary embodiment of the present invention.

FIG. 4 is a top down view of the stand-alone modular tray of FIG. 2 in accordance with an exemplary embodiment of the present invention.

FIG. 5A is side view of the capillary tube in accordance with an exemplary embodiment of the present invention.

FIG. 5B is top-down view of the capillary material and capillary tube in accordance with an exemplary embodiment of the present invention.

FIG. 6 illustrates top down view of the mat in accordance with an exemplary embodiment of the present invention.

FIG. 7 is a 3D view of a section of a self-watering modular planter in accordance with an exemplary embodiment of the present invention.

FIG. 8 is a flow chart illustrating a method for manufacturing a self-watering modular planter for growing plants and vegetables in limited spaces in an urban area in accordance with an exemplary embodiment of the present invention.

### DETAILED DESCRIPTION OF THE INVENTION

The invention is detail described with reference to the drawings provided as illustrative examples of the invention.

Referring now to FIG. 1 which presents an overview of a completely assembled self-watering modular planter 100 that facilitates the growing of plants and vegetables anywhere and in any available space in accordance with an exemplary embodiment of the present invention is illustrated.

More particularly, self-watering modular planter 100 includes a plurality of modular trays 101 connected together into an N by M array of growing medium, where N and M are positive integer different from zero. An extendable frame skeleton 102 is configured to secure plurality of modular trays 101 together and to provide means for support vine type plants such as beans, peas, cucumbers, and tomatoes. The detailed descriptions of plurality of modular trays 101 and extendable frame skeleton 102 will be described in the following figures.

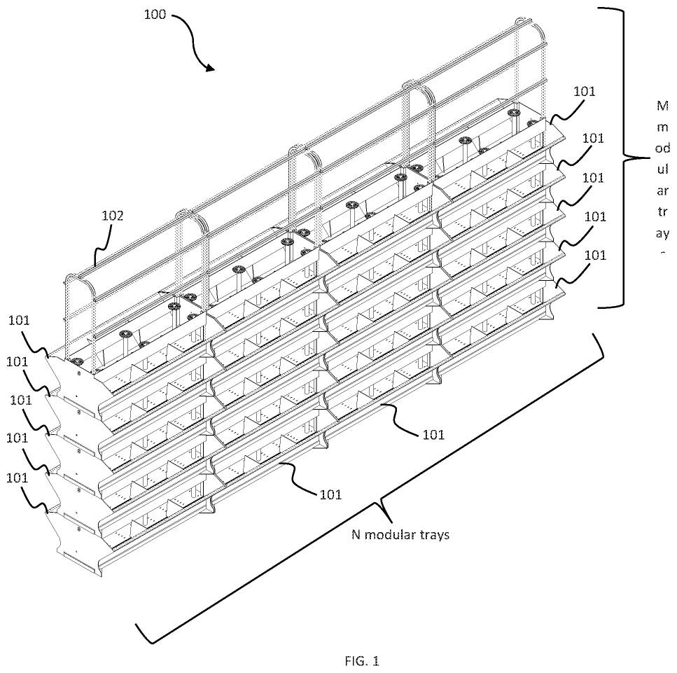

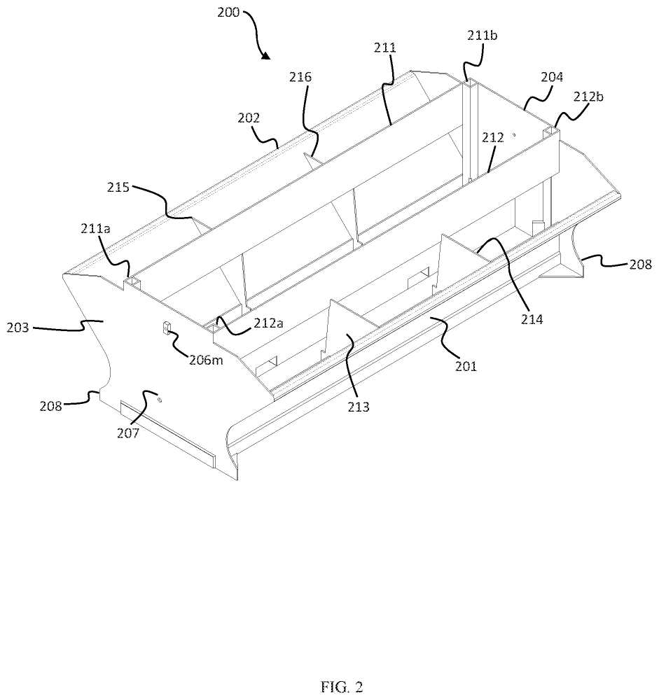

Referring next to FIG. 2, a three-dimensional (3D) diagram illustrating the internal structure of a stand-alone modular tray 200 configured to provide self-watering growing medium in accordance with an exemplary embodiment of the present invention is illustrated. Modular tray 200 has a front side 201, a rear side 202, a left side 203, and a right side 204. An interior space inside each modular tray 200 further comprises: a first bar member 211 welded to both left side 203 and right side 204 spanning across the length of modular tray 200; a second bar member 212, welded to both left side 203 and right side 204 spanning across the length of modular tray 200, disposed parallel to first bar member 203. A plurality of dividers 213, 214, 215, and 216 are welded to front side 201 and back side 202 of modular tray 200 and perpendicular to first bar member 211 and second bar member 212. In one exemplary embodiment, left side 203 and right side 204 have a fan shape: narrow at the bottom and gradually broadening toward the top. The bottom of modular tray 200 has legs 208 extending downward from four corners. The top side is open to create the maximum growing medium inside modular tray 200. On left side 203, a male connector 206m designed to connect to another modular tray 200. Below male connector 206m, a water outlet 207 is disposed to maintain a constant water level at the bottom of modular tray 200.

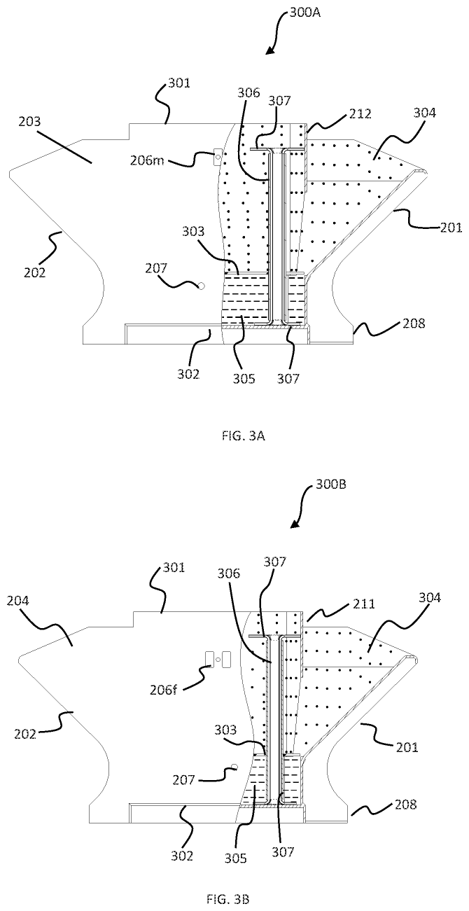

Referring next to FIG. 3A, a planar drawing 300B of the interior of modular tray 200 viewed from left side 203 in accordance with an exemplary embodiment of the present invention is illustrated. As shown, modular tray 200 also includes an open top side 301 and a bottom side 302. The interior of modular tray 200 has a funnel shape. At the neck of the funnel where both sides start to taper up, a bottom surface 302 divides the interior of modular tray 200 into a growing medium 304 and a water tank 305. A bottom surface 303 has a plurality of holes (not shown) for inserting an array of capillary tubes 306. In a specific embodiment, each capillary tube 306 is hollow, made up of poly-vinyl chloride (PVC), and its bottom end is immersed in water tank 305. That means the bottom end of capillary tube 306 does not touch a bottom side 302 of modular tray 200 so that water in water in water tank 305 creates an upward pressure for the capillary action to occur. A capillary material 307 such as cloths, wool, or synthetic mesh, etc. is inserted inside each capillary tube 306 and in fluid communication with water tank 303. In other specific embodiments, capillary tubes 306 is made of glass or other plastic composite materials.

Now referring to FIG. 3B, a planar drawing 300B of the interior of modular tray 200 seen from right side 204 in accordance with an exemplary embodiment of the present invention. As can be seen from right side 204, a female connector 206f is disposed above water outlet 207 which is, in turn, disposed below base 303. Another capillary tube 306 and capillary material 307 are also shown.

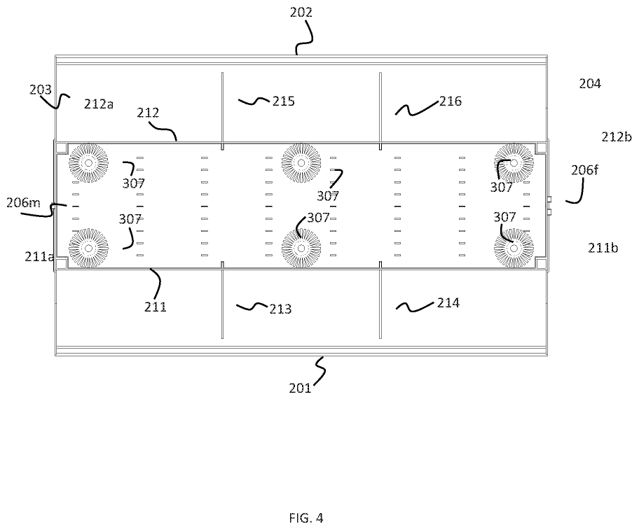

Next, referring to FIG. 4, a top view 400 of the interior of modular tray 200 in accordance with an embodiment of the present invention is illustrated. As can be seen, first bar member 211 and second bar member 212 divides the interior of modular tray 200 into three lengthwise sections: middle section, and two outer sections. In the two outer sections, plurality of dividers 213, 214, 215, and 216 further divides each into three smaller sections for growing plants and vegetables. In the middle section, array of capillary tubes 306 and capillary materials 307 are arranged into an array along the length of the middle section.

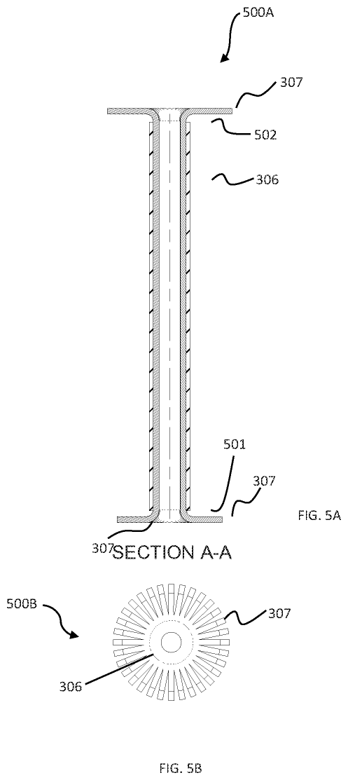

Referring to FIG. 5A, a cross-section 500A of capillary tube 306 and capillary material 307 in accordance with an exemplary embodiment of the present invention is illustrated. In a specific implementation, capillary tube 306 is a hollow cylindrical tube having a distal end 501 and a proximal end 502. Capillary tube 306 is laterally attached to either first bar member 112 or second bar member 113 so that proximal end 502 does not contact bottom surface 303. When water tank 305 is filled with water, the capillary rise occurs inside capillary tube 306. In order to bring the water to the soils, the length of capillary material 307 is intentionally designed to be longer than that of capillary tube 306. Capillary material 307, such as cloth, fiber, synthetic mesh, v.v., is inserted with both ends coming out of capillary tube 306 to make contact with water and soils. Soils are filled modular tray 200 from bottom surface 303 to the rim of distal end 502.

Referring next to FIG. 5B, a top view 500B of capillary tube 306 is illustrated. As capillary material 307 extends out of both ends of capillary tube 306, and it is spread out like a flower to maximize contact points with the soils which are filled up to the rim of distal end 502.

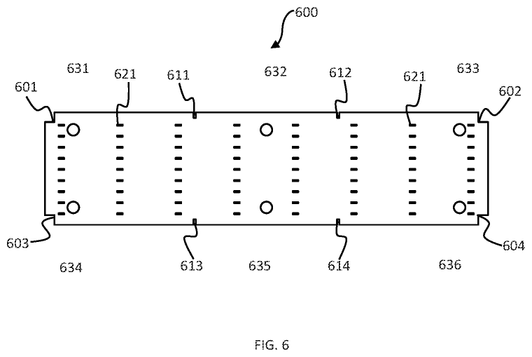

Referring now to FIG. 6, a top view of a mat 600 in accordance with an exemplary embodiment of the present invention is illustrated. In many implementations, mat 600 has a rectangular shape that is posited on top of bottom surface 303. The four corners of mat 600 are cut away to match with frame slots 111a-111b and 112a-112b respectively. In addition, along the lengths of mat 600, four lateral insertion slots 611, 612, 613, and 614 are cut away to fit with dividers 213, 214, 215, and 216 respectively. On the surface area of mat 600, an array of drainage holes 621 are arranged so that excess water from the soils above can return to water tank 305. Mat 600 can be made of plastic or other capillary materials such as sponge, wool, mildew-resistant fabric, polyester fabric, etc. An array of circular openings 631-636 are punctuated along the inner circumference of mat 600 so that array of tubular tubes 306 are inserted there through.

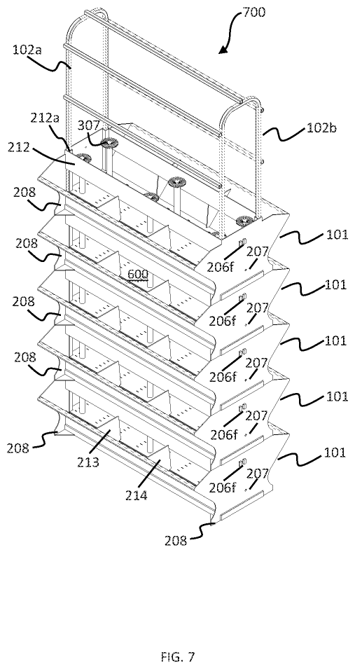

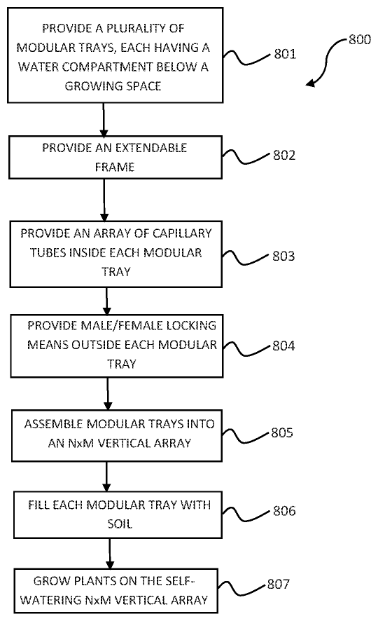

Referring to FIG. 7, a three-dimensional (3D) self-watering modular planter 700 formed by vertically stacking modular tray 101 together in accordance to an exemplary embodiment of the present invention. In most implementations, extendable frame skeleton 102 further comprises a left vertical U-shaped frame 102a and a right vertical U-shaped frame 102b for vertically inserting into slots 111a and 112a and 111b and 112b respectively so as to connect and stabilize modular trays 101. Along the length of left vertical U-shaped frame 102a and right vertical U-shaped frame 102b, a plurality of adjusting holes (not shown) is perforated along its length. Length adjusting locking pins (not shown) are used to firmly lock extendable frame skeleton 102. Horizontal auxiliary tubes 102c are also connected to left vertical U-shaped frame 102a and right vertical U-shaped frame 102b using the same locking means including plurality of adjusting holes and length adjusting locking pins. In some implementations, telescoping tubes are used to extend the length of left vertical U-shaped frame 102a, right vertical U-shaped frame 102b, and horizontal tubes 102c.

Referring again to FIG. 7, after water tank 305 is filled with water, capillary mat 600 is laid on bottom surface 303. Array of capillary tubes 306 and capillary material 307 are inserted into circular openings 631-636 pre-fabricated on the surface area around the inner circumference of bottom surface 303. The same procedure is repeated for the other modular trays 101. Modular trays 101 are vertically stacked so that slots 111a, 112a, 111b, 112b are vertically lined up. Extendable frame skeleton 102 with the right height is calculated and erected based on the number of modular trays 101. In accordance with embodiment of the present invention, the height of extendable frame skeleton 102 is extended higher than the total height of vertically stacked M modular trays 101 so that extendable frame skeleton 102 can serve as a skeleton wall for climbing vines.

Referring back to FIG. 1 and FIG. 2, in order to build an N×M array of modular trays 100 as shown and discussed in FIG. 1, the bottom modular trays 101 are connected together first to form an N bottom modular trays 200. The outermost modular tray 101 is connected with the adjacent modular tray 101 by mating male connector 106m to female connector 106f. The same process is repeated until M modular trays 101 are obtained on the bottom row. Next row up is continued until M vertical modular trays 101 are achieved as shown in FIG. 1. Left vertical U-shaped frames 102a, right vertical U-shaped frames 102b, and horizontal tubes 102c are extended and connected together as discussed above. Soils are then introduced to the growing medium 304 of N×M self-watering modular planter 100. Thus, in accordance with many embodiments of the present invention, self-watering modular planter 700 or N×M self-watering modular planter 100 are used to conveniently grow plants and vegetables in any areas with limited spaces.

Now referring to FIG. 8, a method 800 of manufacturing a self-watering modular planter is illustrated.

At step 801, a plurality of modular bicameral trays, each having a water tank arranged below a growing space, is provided. In many implementations of the present invention, step 801 is realized by modular tray 200 as described in details in FIG. 2 above. That is, each modular bicameral tray has growing medium 304 and water tank 305. Growing medium 304 is further divided into sections by dividers 213, 214, 215, and 216. First bar member 211 and second bar member 212 are arranged in parallel and spanned the length of modular tray 200 so that stand 208 of the next-level up modular tray 200 rests securely thereupon. Frame receptors 211a, 211b, 212a, and 212b are arranged at the four corners where first bar member 211 and second bar member 212 are welded onto left side 203 and right side 204 respectively.

Next at step 802, an extendable frame skeleton that interconnects all modular trays 200 is provided. In many implementations of the present invention, step 802 is realized by providing frame 102 which includes left U-shaped frame 102a, right vertical U-shaped frame 102b, and horizontal tubes 102c, each having adjusting holes and length adjusting locking pins so that extendable frame skeleton 102 can be extended and firmly secured.

At step 803, an array of capillary tubes are provided inside growing space of each modular tray. In many implementations of the present invention, step 803 is realized by array of capillary tubes 306 and capillary materials 307. In many aspects of the present invention, capillary tubes 306 are made of poly-vinyl chloride (PVC) or plastic, while capillary tubes 306 are made of cloth, mesh fabric, or any capillary materials that cause water to seep up from water tank 305 to growing medium 304.

At step 804, male and female locking means are provided on the outside of modular tray. In many implementations of the present invention, step 804 is realized by male connector 102m and female connector 102f. In one exemplary embodiment, male connector 102m has an L-shaped hook originated from the sidewall of modular tray 200 and bent downward. Female connector 102f has the shape of a box formed by two parallel L-shaped hooks originated from the sidewall of modular tray 200 and bent upward.

Next at step 805, modular trays are assembled to form N×M self-watering modular planter. In many implementations of the present invention, step 805 is realized by first connecting male connector 102m to female connector 102f between adjacent modular trays 200 to form a horizontal array of M modular trays. Then next-level up modular trays 200 is stacked on the bottom modular tray 200 laying feet stand 208 onto first bar member 211 and second bar member 212 so that frame opening 213, 214, 215, and 216 are vertically lined up. This process continues until N×M modular bicameral trays 200 is achieved. After that, extendable frame skeleton 102 with the right height is calculated and erected based on the number of modular trays 200. In accordance with embodiment of the present invention, the height of extendable frame skeleton 102 is extended higher than the total height of vertically stacked M modular trays 200 so that extendable frame skeleton 102 can serve as a skeleton wall for climbing vines.

At step 806, each bicameral modular tray is filled with soil. In many implementations of the present invention, each growing medium 304 of modular tray 200 is filled with soil to the rim of capillary tubes 306.

Finally, referring to step 807, different types of plants, vegetables, or tubers can be grown in the N×M self-watering modular planter obtained from steps 801-806 above.

The foregoing description details certain embodiments of the invention. It will be appreciated, however, that no matter how detailed the foregoing appears in the text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should, therefore, be construed in accordance with the appended claims and any equivalents thereof.

### DESCRIPTION OF NUMERALS

100 N×M self-watering modular planter
101 modular trays providing growing medium
102 extendable frame skeleton
102a left vertical U-shaped frame with adjusting holes
102b right vertical U-shaped frame with adjusting holes
102c horizontal tubes
200 a modular tray by itself without capillary tubes
201 front side of the modular tray
202 backside or rear side of modular tray
203 left side
204 right side
206m male connector
206f female connector
207 water outlet opening
208 tray leg
211 first bar member
212 second bar member
213 first divider
214 second divider
215 third divider
216 fourth divider
211a first frame insertion receptor
211b second frame insertion receptor
212a third insertion receptor
212b fourth insertion receptor
303 bottom surface
304 growing media or growing space
305 water tank
306 capillary tube
307 capillary material
501 proximate end (top rim) of capillary tube
502 distal end (bottom rim) of capillary tube
600 (capillary) mat
601 top left cut-away corner of mat
602 top right cut-away corner of mat
603 bottom left cut-away corner of mat
604 bottom right cut-away corner of mat
611 first lateral insertion slot for first divider
612 second lateral insertion slot for second divider
613 third lateral insertion slot for third divider
614 fourth lateral insertion slot for fourth divider
621 array of drainage holes
631 first circular opening for capillary tube
632 second circular opening for capillary tube
633 third circular opening for capillary tube
634 fourth circular opening for capillary tube

What is claimed is:

1. A self-watering modular planter, comprising:
a plurality of modular trays configured to provide a growing medium, each of said modular tray having an open top, a bottom side, a left side, a right side, a front side, and a back side; and
an extendable frame skeleton connected to secure said plurality of modular trays; wherein:
an interior space inside each modular tray further comprises:
a first bar member welded to said left side and said right side spanning across the length of said modular tray;
a second bar member, welded to said left side and said right side spanning across the length of said modular tray, disposed parallel to said first plate;
a plurality of dividers welded to said front side and said back side of said modular tray and perpendicular to said first bar member and said second bar member;
a plurality of receptors disposed on said bottom side, configured to provide means for said extendable frame skeleton to insert therethrough;
a bottom surface vertically dividing said modular tray into a water tank and said growing medium;
an array of capillary tubes, disposed along said bottom surface and in fluid communication with said water tank, operable to provide water to soils of said modular tray by means of a capillary action; and
said left side and said right side further comprises a first connector and a second connector respectively configured to connect to other of said modular trays;
a set of legs, arranged at four corners of said bottom, configured to slide snugly to said first bar member and said second bar member when said plurality of modular trays are stacked vertically.

2. The self-watering modular planter tower claim 1 wherein said water tank further comprises outlets disposed on said left side and said right side of said modular tray.

3. The self-watering modular planter tower claim 1 wherein extendable frame skeleton further comprises:
a plurality of vertical U-shaped frames having a first series of adjusting holes disposed along the length of said vertical U-shaped frames and a first adjusting locking mechanism;
a plurality of horizontal auxiliary tubes having a second series of adjusting holes disposed along the length of said horizontal auxiliary tubes and a second set of adjusting locking mechanism, wherein
the length of said plurality of said vertical U-shaped tubes is extended by inserting said plurality of horizontal auxiliary tubes at either end so as said first series of adjusting holes is lined up with said second series of adjusting holes; and
a plurality of horizontal the length of said plurality of straight tubes is extended by inserting other straight tube to either ends so as said second series of adjusting holes are lined up.

4. The self-watering modular planter tower claim 1 further comprises a mat disposed on said bottom surface of said modular tray.

5. The self-watering modular planter tower claim 4 wherein said mat is a capillary mat having a plurality of layers capable of absorbing and releasing water by the capillary action.

6. The self-watering modular planter tower claim 4 wherein said mat further comprises an array of drainage holes disposed throughout an area of said mat.

7. The self-watering modular planter tower claim 5 wherein said mat further comprises a thin sheet of sponge capable of absorbing and releasing water.

8. The self-water modular planter tower of claim 6 wherein each of said capillary tubes further comprises:
a protecting outer shelf firmly connected to said bottom of each modular tray;
a capillary material inserted inside said protecting outer shelf and in fluid communication with said water tank.

9. The self-water modular planter tower of claim 7 wherein said protecting outer shelf comprises a cylindrical tube and said capillary material comprises a cloth.

10. The self-water modular planter tower of claim 7 wherein said capillary material comprises a fiber capable of drawing water from said water tank to soils filled inside said growing medium.

11. The self-water modular planter tower of claim 7 said left side and said right side each has a fan shape;

12. A method of manufacturing a self-watering modular planter assembly, comprising:
providing a vertical N by M growing medium comprising a plurality of modular trays capable of securely connecting to one another, each of said modular tray having an open top, a bottom side, a left side, a right side, a front side, and a back side, wherein said bottom side of said modular tray is vertically divided into a water tank and a growing medium;
providing an extendable frame skeleton capable of inserting into each of said plurality of modular trays so as to secure said plurality of modular trays;
providing an array of capillary tubes; disposed vertically along said bottom side and in fluid communication with said water tank, operable to provide water to a soil of said modular tray by means of capillary action; and
providing a capillary mat disposed inside each of said modular tray.

13. The method of claim 12 wherein an interior space inside each modular tray further comprises:
a first bar member welded to said left side and said right side spanning across the length of said modular tray;
a second bar member, welded to said left side and said right side spanning across the length of said modular tray, disposed parallel to said first plate;
a plurality of dividers welded to said front side and said back side of said modular tray and perpendicular to said first bar member and said second bar member;
a plurality of receptors disposed on said bottom side, configured to provide means for said extendable frame skeleton to insert therethrough;
a bottom surface vertically divided said modular tray into said growing medium and said water tank;
a set of legs, arranged at four corners of said bottom side, configured to connected to said first bar member and said second bar member when said plurality of modular trays are stacked vertically into said vertical N by M growing medium; and
said water tank further comprising outlets disposed on said left side and said right side of said modular tray.

14. The method of claim 12 wherein said providing an extendable frame skeleton further comprises:
providing a plurality of vertical U-shaped frames having a first series of adjusting holes disposed along the length of said vertical U-shaped frames and first adjusting locking mechanism;
providing a plurality of straight auxiliary tubes having a second series of adjusting holes disposed along the length of said straight tubes and a second set of adjusting locking mechanism, wherein:
the length of said plurality of said vertical U-shaped tubes is extended by inserting said plurality of straight auxiliary tubes at either end so as said first series of adjusting holes is lined up with said second series of adjusting holes; and
providing a plurality of extendable horizontal tubes, connected to said plurality of U-shaped frames in a direction parallel to the length of said modular trays defined by said front side and said back side, wherein
the length of said plurality of extendable horizontal tubes is extended by inserting said straight auxiliary tubes to either ends thereto.

15. The method of claim 12 wherein said capillary mat further comprises an array of drainage holes disposed throughout a surface area of said mat.

16. The method of claim 12 wherein said mat further comprises a thin sheet of sponge capable of absorbing and releasing water.

17. The method of claim 12 wherein each of said capillary tubes further comprises:
a protecting outer shelf firmly connected to said bottom of each modular tray;
a capillary material inserted inside said protecting shelf and in fluid communication with said water tank.

18. The method of claim 14 wherein said protecting shelf comprises a cylindrical tube and said capillary material comprises a cloth.

19. A method of growing plants in a limited space area, comprises:
providing a plurality of modular trays, each of said modular tray having an open top, a bottom, a left side, a right side, a front side, and a back side, wherein said bottom side of said modular tray further comprises a water tank;
providing an extendable frame skeleton capable of inserting into each of said plurality of modular trays so as to secure said plurality of modular trays;
providing an array of capillary tubes, disposed vertically along said bottom side and in fluid communication with said water tank, operable to provide water to a soil of said modular tray by means of capillary action;
providing a plurality of capillary mats each capable of absorbing and releasing water;
providing male and female locking means for securely interlocking said plurality of modular trays together;
laying each of said capillary mats on a bottom surface deposited on top of said water tank from;
assembling said plurality of modular trays and said extendable frame skeleton to form a vertical N by M array of growing medium;
filling each of said modular trays with soil;
filling said water tank with water; and
growing plants in each of said plurality of modular trays.

20. The method of claim 19 wherein each of said capillary tubes further comprises:
a protecting outer shelf firmly connected to said bottom surface of each modular tray;
a capillary material inserted inside said protecting shelf and in fluid communication with said water tank.
